(19) United States
(12) Patent Application Publication
(10) Pub. No.: US 2016/0110544 A1
(43) Pub. Date: Apr. 21, 2016

(54) DISABLING AND INITIATING NODES BASED ON SECURITY ISSUE

(71) Applicant: HEWLETT-PACKARD DEVELOPMENT COMPANY, L.P., Houston, TX (US)

(72) Inventor: Anurag Singla, Sunnyvale, CA (US)

(21) Appl. No.: 14/894,643

(22) PCT Filed: May 30, 2013
(86) PCT No.: PCT/US13/43276

§ 371 Date: Nov. 30, 2015

(51) Int. Cl. G06F 21/55; H04L 29/06

(52) U.S. Cl. CPC G06F 21/554; H04L 63/10; H04L 63/20; G06F 2221/034

(57) ABSTRACT

Example embodiments disclosed herein relate to disabling and initiating nodes based on a security issue. Multiple nodes of a cluster are monitored. It is determined that one of the nodes includes a security issue. The node is disabled. Another node is initiated to replace the disabled node.

### BACKGROUND

Security Information and Event Management (SIEM) technology provides real-time analysis of security alerts generated by network hardware and applications. SIEM technology can detect possible threats to a computing network. These possible threats can be determined from an analysis of security events,

### BRIEF DESCRIPTION OF THE DRAWINGS

The following detailed description references the drawings, wherein:

FIG. 1 is a block diagram of a computing system capable of selectively disabling a node of a cluster based on a detei wined security issue and initiating a replacement node to the cluster, according to one example;

FIG. 2 is a block diagram of a device capable of causing a node of a cluster to be disabled because of a security issue and another node to be loaded to replace the disabled node, according to one example;

FIG. 3 is a flowchart of a method for causing a node of a cluster to be disabled based on a determination that a security issue exists and initiating a replacement node, according to one example;

FIG. 4 is a flowchart of a method for identifying a node of a cluster that is associated with a security issue, according to one example; and

FIG. 5 is a block diagram of a security manager, according to one example.

### DETAILED DESCRIPTION

Security information/event management (SIM or SIEM) systems are generally concerned with collecting data from networks and networked devices that reflect network activity and/or operation of the devices and analyzing the data to enhance security. For example, data can be analyzed to identify an attack on the network or a networked device and determine which user or machine is responsible. If the attack is ongoing, a countermeasure can be performed to thwart the attack or mitigate the damage caused by the attack. The data that can be collected can originate in a message (e.g., an event, alert, alarm, etc.) or an entry in a log file, which is generated by a networked device. Example networked devices include firewalls, intrusion detection systems, servers, etc. In one example, each message or log file entry (“event”) can be stored for future use. Stored events can be organized in a variety of ways.

There are numerous internet protocol (IP) address based devices on the Internet and/or other networks. Many of these devices may have malicious code executing. Traffic from any of the potentially malicious devices to an enterprise should be scrutinized for any malicious behavior. Also, the kind of attack pattern from these devices and the vulnerabilities that these devices can exploit can vary over a large range. SIEM technology can identify a large range of risks and/or exploits.

Cloud computing is the usage of computing resources from a remote location and accessible over a network. As such, users can purchase and/or otherwise use the resource itself instead of each of the hardware components as well as the associated platform software. As such, users can purchase the resource on demand. Cloud systems can be implemented using a cluster of networked computers. Cloud computing centers should be secured. However, it can be difficult to determine which machines have security issues.

Accordingly, various embodiments disclosed herein relate to securing cloud applications by monitoring the security events related to applications and the machines on which the respective applications run. In one example, an application is a program that can be executed by the node other than the programs used to operate the node. Applications can include services that can be provided over the Internet to other devices. Monitoring security events can be used to prevent the compromise of data in the cloud by actively taking action on compromised machines and disallowing further access to the machine by an attacker. It can also be used in non-cloud environments where spare machines are available for hot deployment in case security of one or more machines in the environment is compromised.

Further, with the approaches described herein, the availability of the application need not suffer because the compromised machines can be recycled after evidence detection of the security issue. Moreover, new machines in the environment can be spawned to balance the load affected by making the compromised node unavailable.

A security manager can be enhanced to understand the cloud deployment of various applications that use a cluster of virtual machines (nodes) for load balancing and/or scaling. If a node's security is compromised, the node can be brought down and a new node initiated. In some examples, the new node can have a new Internet Protocol address and can be clean from infection. Additionally or alternatively, the security manager can cause quarantine of the infected node and monitor activity to understand the impact of the security issue. The node can be brought down after the impact study.

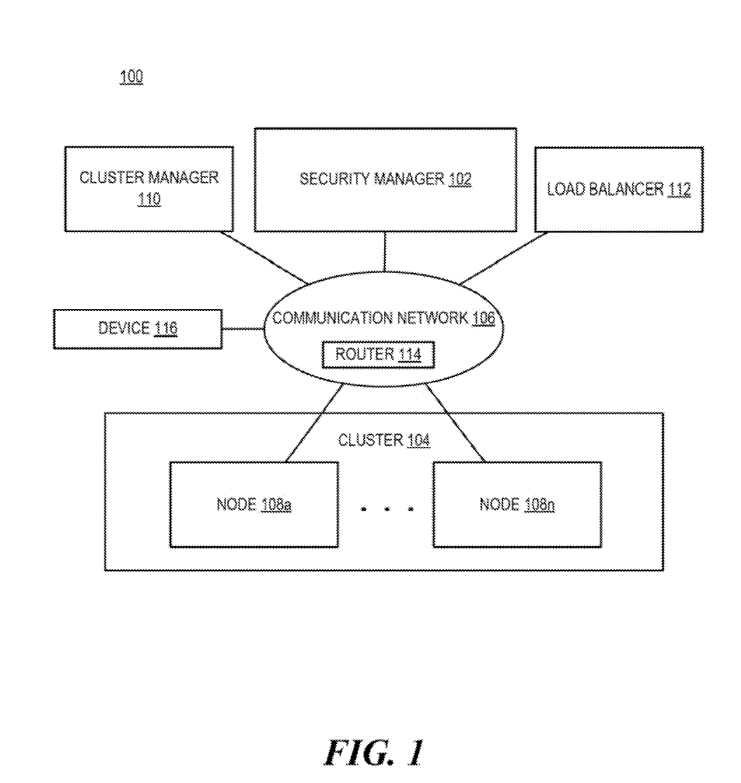

FIG. 1 is a block diagram of a computing system capable of selectively disabling a node of a cluster based on a determined security issue and initiating a replacement node to the cluster, according to one example The system 100 can include a security manager 102 that communicates with a cluster 104 via a communication network 106. The cluster can include nodes 108a-108n, a cluster manager 110, a load balancer 112, combinations thereof, etc. Moreover, the communication network 106 may include one or more routers 114, network switches, etc. In certain examples, the security manager 102, nodes 108a-108n, cluster manager 110, and/or load balancer 112 can be computing devices, such as servers, client computers, desktop computers, mobile computers, workstations, etc. In other embodiments, the devices can include special purpose machines. In some examples, one or more of the devices can be implemented via a processing element, memory, instructions, and/or other components.

The duster 104 can include loosely connected or tightly connected computing devices (nodes 108) that work together. The components of the duster can be connected through a network, such as a fast local area network (LAN). In some examples, each node 108 can execute its own instance of an operating system. Activities of the cluster 104 can be managed using clustering middleware, which can be considered a layer of software that sits on the nodes and allows users to treat the cluster as a large cohesive computing unit. In some examples, the cluster 104 can be of high-availability. As such, the cluster 104 can support server applications that can be used with a minimum of down-time. High-availability clustering allows for bringing down an application on a computing device that fails and restarting the application on another computing device. As part of the process, clustering software can configure the new node before starting the brought down application on it.

The security manager 102 can monitor the nodes. Further, the security manager 102 can determine whether one of the nodes 108 has a security issue based on analyzing data. Monitoring the nodes 108 can include monitoring a log from the respective nodes, monitoring activity from an intrusion prevention system (IPS), monitoring activity from a router 114, or the like. Further, in some examples, nodes 108 may include an agent that can be used to provide log information and/or other information to the security manager 102.

In one example, the security manager 102 can be a SIEM. In some examples, a security issue is a determination that the node 108 may be compromised based on the analysis. The security manager 102 can correlate information gathered from these sources and/or other sources and analyze the information to determine whether one or more of the nodes 108 has a security issue. For example, the security manager 102 can compare activity (e.g., network traffic) at a node 108 to a known pattern or flag the activity based on one or more rules. Moreover, the IP address of a node can be flagged as suspicious based on the analysis. In one example, the node can be considered compromised if suspicious activity occurring on network traffic associated with the node.

Each of the nodes 108 can be tracked by the security manager 102. In some examples, information about the node 108, the IP address of the node 108, logs of the node 108, applications running on the node 108, services running on the node 108, etc. can be kept by the security manager 102. In some scenarios, a REST script can ask the individual machines about what services are associated with the machine. Moreover, information about the nodes 108 can be determined in real time by asking the machines or a cluster manager 110 that may keep track of the applications/services associated with each of the nodes. In one example, a table or database can be kept to keep track of applications/services associated with the respective nodes of the cluster 104. Further, multiple clusters of nodes can be monitored by the security manager 102. Moreover, an agent of the security manager 102 may be implemented on the respective nodes to provide information about the node to the security manager 102.

When the security manager 102 determines that a node 108a has a security issue, the security manager 102 can cause the node 108a to be disabled. In one example, the node can be disabled by blocking communication access to the node 108a from at least one entity. In some examples, the entity may be a device 116 that may be attempting to attack the node 108a. The security manager 102 may be aware of the network configuration associated with the respective nodes 108 of the cluster 104. As such, the security manager 102 may have access to information about one or more ports of a router 114 associated with the node 108a. The security manager 102 can cause the node 108a to be disabled by sending a message to a router 114 in the path of the node 108a to block communication access to the node 108a.

In some scenarios, the communication is blocked from devices other than the security manager 102. As such, the security manager can collect information from the node 108a while the node 108a is disabled by blocking communication access to outside devices and/or other devices of the cluster 104. The security manager 102 can analyze the information to determine an exploit associated with the node 108. In one example, the exploit to be determined can be information the attack may have been attempting to access. In another example, the exploit could be to attack a particular IP address associated with the cluster (e.g., to overload the node and/or to attempt to gather information). In this case, information that the IP address is being attacked can be noted and used in further analysis. The node 103a can also be disabled by shutting down the node 108a. In one example, the node 108a is shut down before any analysis occurs. In another example, the node 108a can be shut down after disabling communications to the node 108a and collecting information. An agent of the security manager 102 can be resident on the nodes to help collect information about the nodes.

The security manager 102 can further cause another node to be initiated to replace the node 108a in the cluster 104. The initiated node can be initiated by a load balancer 112 based on a copy of one or more applications that were previously executing on the node 108a replaced. In some examples, the other node is initiated based on a message sent to the load balancer 112 by the security manager 102. The message can include information that the node 108a was disabled (e.g., shutdown, blocked from communication, etc,) explicit instructions to load another node, configuration information (e.g., a request not to use the same IP address as node 108a, which applications should be loaded, etc.) for the other node, or the like. The copy used can be a golden copy that is trusted as the starting point. Further, the copy's version can match the version of the copy being executed on node 108a.

The communication network 106 can use wired communications, wireless communications, or combinations thereof. Further, the communication network 106 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 106 can be in the form of a direct network link between devices. Various communications structures and infrastructure can be utilized to implement the communication network(s).

By way of example, the devices communicate with each other and other components with access to the communication network 106 via a communication protocol or multiple protocols. A protocol can be a set of rules that defines how nodes of the communication network 106 interact with other nodes. Further, communications between network nodes can be implemented by exchanging discrete packets of data or sending messages. Packets can include header information associated with a protocol (e.g., information on the location of the network node(s) to contact) as well as payload information. Moreover, various types of configurations to the communication network can be used so that one or more of the devices can be in the path from one of the devices to another.

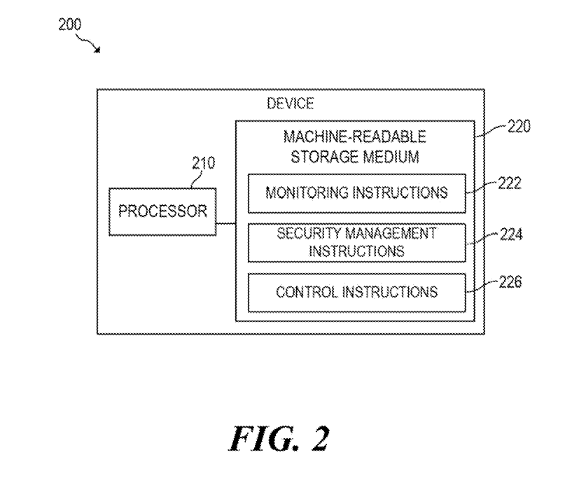

FIG. 2 is a block diagram of a device capable of causing a node of a cluster to be disabled because of a security issue and another node to be loaded to replace the disabled node, according to one example. The device 200 includes, for example, a processor 210, and a machine-readable storage medium 220 including instructions 222, 224, 226 for replacing a node of a cluster based on a detected security issue. Device 200 may be, for example, a notebook computer, a server, a workstation, a desktop computer, or any other computing device.

Processor 210 may be, at least one central processing unit (CPU), at least one semiconductor-based microprocessor, at least one graphics processing unit (GPU), other hardware devices suitable for retrieval and execution of instructions stored in machine-readable storage medium 220, or combinations thereof. For example, the processor 210 may include multiple cores on a chip, include multiple cores across multiple chips, multiple cores across multiple devices (e.g., if the device 200 includes multiple node devices), or combinations thereof. Processor 210 may fetch, decode, and execute instructions 222, 224, 226 to implement methods 300 and/or 400. As an alternative or in addition to retrieving and executing instructions, processor 210 may include at least one integrated circuit (IC), other control logic, other electronic circuits, or combinations thereof that include a number of electronic components for performing the functionality of instructions 222, 224. 226.

Machine-readable storage medium 220 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 220 may be encoded with a series of executable instructions for monitoring nodes of a cluster for security issues and disabling a node and initiating a replacement node.

The device 200 can be used to implement a security manager. for example security manager 102. As such, the device 200 can execute monitoring instructions 222 to monitor a plurality of nodes of a cluster. Multiple clusters can be monitored as well as other devices. As discussed herein, monitoring can include aggregation of data through various logs from multiple sources, which can include the node, routers, other nodes, other network devices, servers, databases, applications, etc.

The device 200 can execute security management instructions 224 to correlate the monitored information. For example, the device 200 can look for common attributes and link events together into meaningful groups. Various logs can be correlated together from different sources to turn that data into useful security information. The correlated information can be analyzed based on rules and/or patterns. As such, an automated analysis of the correlated events can be used to determine one or more alerts. Some of the alerts can be considered a security issue. In some examples, a security issue can be labeled as an alert that triggers disabling of a node. In some examples a node can be determined based on an association of an IP address associated with the node to a security issue. Further, the security issue can be identified based an information from the monitoring and an IP address associated with the node.

Control instructions 226 can be executed to cause a node associated with a security issue to be disabled. In one example, disabling the node can include shutting down the node. This can be done, for example, by sending a message to node to shut down the node. An agent can be placed on the node, or cluster middleware software can be used to receive the message and shut down the node. In another example, the device 200 can cause the node to be disabled by causing blocking of communication access to the node from at least one entity. In one example. the entity could be an attacker. In another example, the blocking could be from all other entities other than the device 200. As such, the device 200 can collect information from the node. Further, the information can be processed to determine exploit information associated with the node. The exploit information can represent information about data that the security issue may have been associated with or targeted, information that was compromised, other information that may be helpful in determining an identity of an attacker or what the attack may have been targeted towards, etc. In some examples, when exploit information is collected, the node can be brought down.

The device 200 can also cause another node to be initiated to replace the node in the cluster. The initiated node can also be caused to be loaded with an application associated with the node to be replaced (e.g., using a golden copy of the application or other applications/services to load). In one example, the device 200 can cause this by sending a message to a load balancer or cluster manager to initiate the replacement node. In another example, the device 200 can cause this as part of a shutdown procedure of the node.

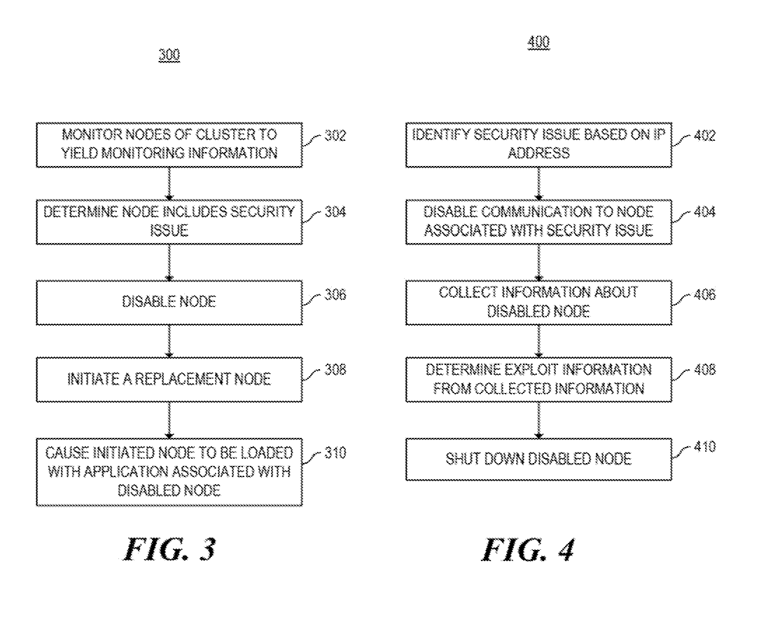

FIG. 3 is a flowchart of a method for causing a node of a cluster to be disabled based on a determination that a security issue exists and initiating a replacement node, according to one example. Although execution of method 300 is described below with reference to security manager 102, other suitable components for execution of method 300 can be utilized (e.g., device 200). Additionally, the components for executing the method 300 may be spread among multiple devices. Method 300 may be implemented in the form of executable instructions stored on a machine-readable storage medium, such as storage medium 220, and/or in the form of electronic circuitry.

A security manager 102 can monitor multiple nodes of a cluster to yield monitoring information (302). The monitoring information can be collected via one or more SEM approaches. Further, the monitoring information can also include a mapping of the individual nodes of the cluster. This can be managed, for example, by associating each of the nodes with respective IP addresses or another identifier. This can allow the security manager 102 to tie events happening to/at a respective node of the cluster.

At 304, the security manager 102 can determine one of the nodes includes a security issue based on the monitoring information. The security manager 102 can determine the issue using SIEM approaches as detailed above. Then, at 306, the security manager 102 can cause the node to be disabled based on the determination that the node has a security issue. The disabling can occur by causing another device or set of devices (e.g., a router, switch, etc.) to disable communications from the node, by causing another device (e.g., a cluster manager 110, a load balancer 112, etc.) to shut down the node, by shutting down the node using a command, combinations thereof, or the like.

At 308, the security manager 102 can cause another node to be initiated to replace the node in, the cluster. The initiation can occur using another device, such as a cluster manager 110, load balancer 112, etc. and/or by sending one or more commands to the node itself (e.g., in the case that a node is waiting in standby and has an agent or other software capable of initiating based on commands) from the security manager). Then, at 310, the initiated node can further be caused to be loaded with an application associated with the disabled node. In one example, information about applications associated with the node can be saved and be available to the security manager 102 and/or another initiating device. The information can further link a copy of the respective applications to the respective nodes. The copies can be transferred to the node to load the node with the application(s).

FIG. 4 is a flowchart of a method for identifying a node of a cluster that is associated with a security issue, according to one example. Although execution of method 400 is described below with reference to security manager 102, other suitable components for execution of method 400 can be utilized (e.g., device 200). Additionally, the components for executing the method 400 may be spread among multiple devices. Method 400 may be implemented in the form of executable instructions stored on a machine-readable storage medium, such as storage medium 220, and/or in the form of electronic circuitry.

As noted, the security manager 102 can monitor information about nodes of a cluster. Analysis can be used to identify a security issue based on an IP address (402). The IP addresses of the respective nodes can be known and used as a way to track the respective nodes. SIEM analysis can be performed on the information tracked using the IP address as a key. Identification of the security issue can be made based on SIEM event management and correlation functionality and can include a customizable portion to more specifically define elements of a security issue (e.g., a pattern of traffic, a threshold for the severity of a possible issue before it becomes a security issue, etc.).

Then, at 404, the security manager 102 can cause the node to be disabled by causing blocking of communication access to the node from entities other than the security manager 102 as noted above. The security manager 102 can then collect information about the disabled node at 406. Collecting of information can include monitoring attempts at communication with the node from outside computing devices, requesting and receiving logs from the node (e.g., via middleware or an agent on the disabled node), etc. The collected information can be analyzed using correlation techniques and SIEM functionality to determine exploit information associated with the disabled node (408). At 410, the disabled node is shut down. This can occur at a point after the information about the disabled node is collected.

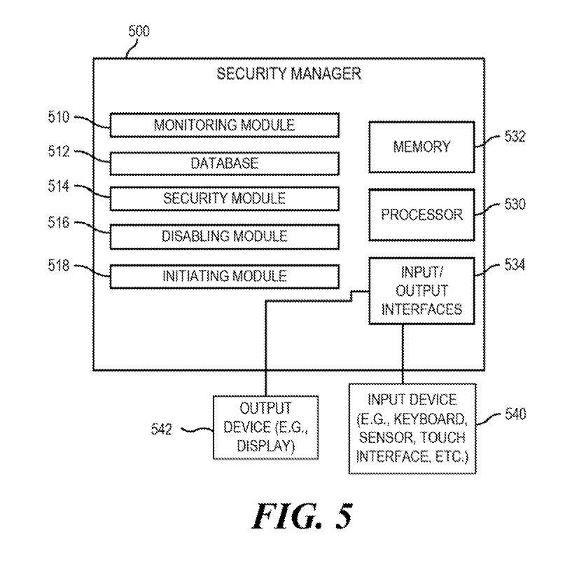

FIG. 5 is a block diagram of a security manager, according to one example. Security manager 500 includes components that can be utilized to monitor, disable, and initiate nodes of a cluster based on a security issue. The respective security manager may be a computing device such as a server, workstation, appliance, etc. that can monitor nodes of a cluster.

The monitoring module 510 can monitor nodes of a cluster and/or other devices to perform SIEM functionality. As noted above, the monitoring can include logs of multiple devices in the network associated with the cluster including devices such as routers, the security manager, databases, servers, the nodes, switches, etc. The monitored information can be processed and/or correlated and monitoring information can be stored in a database 512.

The security module 512 can process the monitoring information to determine whether one or more security issues exist. In some examples, a security issue can be defined by one or more rules. In another example, a security issue can be identified by performing pattern discovery on the activity from one or more nodes. As such, an automated analysis of correlated events can be used to generate an alert associated with what is considered a security issue. When a security issue is detected, the node associated with the security issue can be determined. In some examples, a table or other data structure can be kept to map nodes to IP addresses and/or other identifiers that can be used to identify the node.

When a security issue arises, the disabling module 516 can cause disabling of the node. As noted above, the disabling can be in the form of disabling communications and/or shutting down the individual node. Another node can be initiated by the initiating module 518. Additionally, the node can be loaded as part of the initiation with a copy of the programs executing on the node.

In some examples, the security module 514 can analyze a disabled node for additional information. As such, the security module 514 can request information from the node (e.g., via an agent on the node, request logs, etc.) and receive the information. This information can be used to determine other information about the attack, including, for example, alerting an administrator, determining an attacker, determining how the attack is implemented to stop future attacks, etc. In some examples, the IP address associated with the node is determined to be associated with the attack. Because it is associated with the attack, the IP address can be blocked until after the attack stops. As such, initiated nodes can be started with differing IP addresses.

A processor 530, such as a central processing unit (CPU) or a microprocessor suitable for retrieval and execution of instructions and/or electronic circuits can be configured to perform the functionality of any of the modules 510, 514, 516, 518 described herein. In certain scenarios, instructions and/or other information, such as a database 512 of monitored information, can be included in memory 532 or other memory. Input/output interfaces 534 may additionally be provided by the security manager 500. For example, input devices 540, such as a keyboard, a sensor, a touch interface, a mouse, a microphone, etc. can be utilized to receive input from an environment surrounding the security manager 500. Further, an output device 542, such as a display, can be utilized to present information to users. Examples of output devices include speakers, display devices, amplifiers, etc. Moreover, in certain embodiments, some components can be utilized to implement functionality of other components described herein.

Each of the modules 510, 514, 516, 518 may include, for example, hardware devices including electronic circuitry for implementing the functionality described herein. In addition or as an alternative, each module 510, 514, 516, 518 may be implemented as a series of instructions encoded on a machine-readable storage medium of security manager 500 and executable by processor 530. It should be noted that, in some embodiments, some modules are implemented as hardware devices, while other modules are implemented as executable instructions.

What is claimed is:

1. A computing system comprising:
a plurality of nodes of a cluster:
a security manager to monitor the nodes, wherein the security manager is further to determine that one of the nodes includes a security issue,
wherein the security manager causes the one node to be disabled, and
wherein another node is caused to be initiated to replace the one node in the cluster.

2. The computing system of claim 1, wherein the one node is disabled by blocking communication access to the one node from at least one entity.

3. The computing system of claim 2, wherein the security manager collects information from the one node while the one node is disabled; and wherein the security manager determines an exploit associated with the one node based on the information.

4. The computing system of claim 2, further comprising:
a router, wherein the security manager notifies the router to block the communication access to the one node.

5. The computing system of claim 1, wherein the one node is disabled by shutting down the one node.

6. The computing system of claim 1, further comprising:
a load balancer to cause initiation of the replacement node based on a copy of one or more applications that were previously executing on the one node.

7. The computing system of claim 1, wherein monitoring the nodes comprises at least one of: monitoring a log from the respective nodes, monitoring activity from an intrusion prevention system, and monitoring activity from a router.

8. The computing system of claim 7, wherein the monitoring further based on the Internet Protocol address of the one node.

9. A non-transitory machine-readable storage medium storing instructions that, if executed by at least one processor of a device, cause the device to;
monitor a plurality of nodes of a cluster;
determine that one of the nodes includes a security issue;
cause the one node to be disabled based on the determination; and
cause another node to be initiated to replace the one node in the cluster, wherein the initiated node is further caused to be loaded with an application associated with the one node.

10. The non-transitory machine-readable storage medium of claim 9, further comprising instructions that, if executed by the at least one processor, cause the device to:
identify the security issue based on information from the monitoring and an Internet Protocol address associated with the one node.

11. The non-transitory machine-readable storage medium of claim 9, further comprising instructions that, if executed by the at least one processor, cause the device to:
cause the one node to be disabled by blocking communication access to the one node from at least one entity;
collect information from the one node while the one node is disabled;
determine exploit information associated with the one node based on the information.

12. The non-transitory machine-readable storage medium of claim 9, further comprising instructions that, if executed by the at least one processor, cause the device to:
cause shutting down of the one node.

13. A method comprising:
monitoring a plurality of nodes of a cluster at a security manager to yield monitoring information;
determining that one of the nodes includes a security issue based on the monitoring information;
causing the one node to be disabled based on the determination; and
causing another node to be initiated to replace the one node in the duster, wherein the initiated node is further caused to be loaded with an application associated with the one node.

14. The method of claim 13, further comprising:
identifying the security issue based the monitoring information and an Internet Protocol address associated with the one node.

15. The method of claim 13, further comprising:
causing the one node to be disabled by causing blocking of communication access to the one node from entities other than the security manager;
collecting information from the one node while the one node is disabled; and
determining exploit information associated with the one node based on the information.
